(19) United States
(12) Patent Application Publication
(10) Pub. No.: US 2012/0064365 A1
(43) Pub. Date: Mar. 15, 2012

(54) SLIDE MEMBER

(75) Inventors: Satoshi TAKAYANAGI, Inuyama-shi (JP); Yi Zhang, Inuyama-shi (JP); Hiroyuki Asakura, Inuyama-shi (JP); Yukihiko Kagohara, Inuyama-shi (JP)

(73) Assignee: DAIDO METAL COMPANY LTD., Nagoya-shi (JP)

(21) Appl. No.: 13/233,273

(22) Filed: Sep. 15, 2011

(30) Foreign Application Priority Data
Sep. 15, 2010 (JP) 2010-206673

(51) Int. Cl. B32B 15/01

(52) U.S. Cl. 428/648

(57) ABSTRACT

A slide member is disclosed. The slide member includes a bearing alloy layer, a Ni-based intermediate layer provided over the bearing alloy layer, and a Sn-based overlay provided over the Ni-based intermediate layer. The Sn-based overlay comprises at least one layer, the Sn-based overlay including a first layer or region having a sliding surface and a second layer or region placed in contact with the Ni-based intermediate layer. The first layer or region contains Sn and 3 mass % or more of Cu and the second layer or region contains Sn and 8 mass % or less of Cu.

### CROSS-REFERENCE TO RELATED APPLICATION(S)

This application is based upon and claims the benefit of priority from the prior Japanese Patent Application No. 2010-206673, filed on, Sep. 15, 2010 the entire contents of which are incorporated herein by reference.

### FIELD

The present invention relates to a slide member provided with a Sn-based overlay formed over a bearing alloy layer through a Ni-based intermediate layer.

### BACKGROUND

A slide member comprising a bearing alloy layer, an intermediate layer, and a Sn-based overlay laminated in the listed sequence exhibits outstanding anti-fatigue properties and is used in applications such as slide bearings for internal combustion engines of automobiles. Such slide members are disclosed, for instance in JP 2001-247995 A and JP 2007-501898 A.

The slide member disclosed JP 2001-247995 A is made of a laminate of a bearing alloy layer and an Sn-based overlay with a double layered intermediate layer interposed therebetween. More specifically, the slide bearing is made of a bearing alloy layer, a first Ni-based intermediate layer containing Ni provided over the bearing alloy layer, a second Ni-based intermediate layer containing Sn and Ni provided over the first Ni-based intermediate layer, and a Sn-based overlay provided over the second Ni-based intermediate layer. The Sn-based overlay contains 39 to 55 mass % of Cu. JP 2001-247995 A achieves improvement in the anti-fatigue properties of the slide member by increasing Cu concentration within the Sn-based overlay by the diffusion of Sn from the Sn-based overlay to the intermediate layer.

The slide member disclosed in JP 2007-501898 A is provided with a Ni-based intermediate layer which is lined by Sn-based overlay containing 0.5 to 20 mass % of Cu. The slide member is configured, when heated in high temperature applications such as internal combustion engines, such that Ni within the Ni-based overlay forms a bond with Sn in the Sn-based overlay to form a Sn—Ni system compound having outstanding anti-seizure properties. JP 2007-501898 A achieves improved anti-seizure properties by the above described configuration.

JP 2001-247995 A discloses a slide member provided with an Ni-based intermediate layer consisting of Sn and Ni which is electroplated over the underlying structure. Such Ni-based intermediate layer is difficult to form and thus unproductive since its ingredients are prone to exhibit an uneven distribution and its surface is frequently coarsened.

The slide member disclosed in JP 2007-501898 A, when heated in operation, forms a Sn—Ni system compound having outstanding anti-seizure properties as mentioned earlier. However the heat also allows formation of a layer of a Sn—Ni—Cu compound which is disadvantageous in terms of anti-seizure properties, and thus, the slide member disclosed in JP 2007-501898 A may not provide sufficient anti-seizure properties in rigorous conditions imposed by recent applications.

### SUMMARY

One object of the present invention is to provide a slide member having outstanding anti-fatigue and anti-seizure properties which are manufacturable with improved productivity.

A slide member according to one embodiment of the present invention includes a bearing alloy layer, a Ni-based intermediate layer provided over the bearing alloy layer, and a Sn-based overlay provided over the Ni-based intermediate layer. The Sn-based overlay is made of at least one layer. In case the Sn-based overlay is made of one layer, the layer includes a first region having a slide surface and a second region placed in contact with the Ni-based intermediate region. In case the Sn-based overlay is made of more than one layer, the one or more layers include a first layer having a slide surface and a second layer placed in contact with the Ni-based intermediate region. The first layer/region contains Sn and 3 mass % or more of Cu and the second layer/region contains Sn and 8 mass % or less of Cu.

The bearing alloy layer may comprise, for instance, a Cu-based bearing alloy layer or an Al-based bearing alloy layer. The Cu-based bearing alloy layer may be made of Cu or Cu alloy containing non-Cu elements. Examples of such Cu alloy include Cu—Sn alloy, Cu—Sn—Bi alloy, and Cu—Sn—Pb alloy. The Al-based bearing alloy layer may be made of Al or Al alloy containing non-Al elements. Examples of such Al alloy include Al—Sn alloy, Al—Sn—Si alloy, and Al—Zn—Si alloy.

The bearing alloy layer may be provided over a backing made of metal such as iron.

The Ni-based intermediate layer according to one embodiment of the present invention serves as a bonding layer that facilitates the bonding of the bearing alloy layer and the Sn-based overlay. The Ni-based intermediate layer also serves as a diffusion barrier layer that substantially prevents formation of brittle compounds by suppressing the diffusion of Sn within the Sn-based overlay into the bearing alloy layer. The Ni-based intermediate layer is made of Ni or Ni alloy. Examples of Ni alloy include Ni—Cr alloy, Ni—Fe alloy, and Ni—Co alloy.

The Ni-based intermediate layer may be a laminate. In such case, each layer consists of Ni or any one of the above described Ni alloy.

The Sn-based overlay contains Cu in the Sn matrix and other elements as required. Sn within the Sn-based overlay improves the toughness of the Sn-based overlay and consequently improves its anti-fatigue properties. Cu content within the Sn-based overlay increases the strength of the Sn-based overlay.

The Cu content within the Sn-based overlay, however, risks the possibility of forming Sn—Ni—Cu system compound that is relatively seizure prone by the bonding of Ni originally contained in the Ni-based intermediate layer and Sn and Cu within the Sn-based overlay. However, when the slide member is heated in a high temperature application such as internal combustion engines, the heat facilitates the diffusion of Sn within the Sn-based overlay toward the Ni-based intermediate layer and promotes formation of a layer of Sn—Ni system compound such as Ni₃Sn₄ at the interface of the Sn-based overlay and the Ni-based intermediate layer through the bonding of Ni originally contained in the Ni-based intermediate layer and Sn contained in the Sn-based overlay. The outstanding anti-seizure properties of the Sn—Ni system compound improve the anti-seizure properties of the slide member. The application of the above described slide member allows improvement of the anti-seizure properties of the slide member without having to form an Ni-based intermediate layer containing Sn and Ni at the point of manufacture.

The Sn-based overlay is made of at least one layer. In case the Sn-based overlay is a laminate, the topmost layer placed in contact with a counter member in operation is referred to as a Sn-based slide layer and the lowermost layer placed in contact with the Ni-based intermediate layer is referred to as a Sn-based bottom layer.

In case the Sn-based overlay is a double layer, the Sn-based slide layer is provided above the Sn-based bottom layer.

In case the Sn-based overlay is a single layer, the Sn-based slide layer and the Sn-based bottom layer coincide in the same layer. Assuming a single layered Sn-based overlay, when the Sn-based overlay is thicker than 2 μm and possess a compositional concentration gradient in the direction of its thickness, 2 μm of the Sn-based overlay measured from the interface with the Ni-based intermediate layer is referred to as the Sn-based bottom region, and the rest of the Sn-based overlay is referred to as the Sn-based slide region.

The thickness direction, mentioned above, indicates the direction orthogonal to the slide surface of the Sn-based overlay with an assumption that the slide surface is a horizontal surface.

In case the Sn-based overlay is made of three or more layers, the Sn-based overlay comprises a Sn-based slide surface, a Sn-based bottom surface, and one or more layers of Sn-based mid layers interposed therebetween. Each layer contains elements other than Sn within the Sn matrix.

The Sn-based slide layer/region of the Sn-based overlay contains 3 mass % or more of Cu. The Cu content of 3 mass % or more allows the Sn-based slide layer/region and consequently the Sn-based overlay to exert outstanding anti-fatigue properties. The Cu content is preferably 12 mass % or less. The Cu content of 12 mass % or less within the Sn-based slide layer/region adds toughness to the Sn-based overlay without becoming excessively hard to provide a good restraint to degradation of anti-fatigue properties of the Sn-based overlay.

The Sn-based bottom layer/region of the Sn-based overlay contains 8 mass % or less of Cu. Cu content of 8 mass % or less relatively reduces the amount of Sn—Ni—Cu system compound formation and consequently minimizes the formation of a layer of Sn—Ni—Cu system compound at the interface of the Sn-based overlay and the Ni-based intermediate layer by the bonding of Ni originally contained in the Ni-based intermediate layer and Sn and Cu within the Sn-based overlay. Because Sn—Ni—Cu system compound is relatively seizure prone, the above described slide member exhibits outstanding anti-seizure properties through the reduced amount of Sn—Ni—Cu system compound formation.

Sn-based bottom layer/region preferably contains 5 mass % or less of Cu. Cu content of 5 mass % or less further reduces the amount of Sn—Ni—Cu system compound formation and consequently further minimizes the formation of a layer of Sn—Ni—Cu system compound and thus, provides a slide member having further improved anti-seizure properties. In case the Sn-based overlay is made of two or more layers, the Sn-based bottom layer need not contain any Cu.

Among the layers of the Sn-based overlay, the Sn-based bottom layer/region placed in contact with the Ni-based intermediate layer is preferably 0.5 μm thick or thicker. The Sn-based bottom layer/region, having a thickness of 0.5 μm or thicker, renders Cu within the Sn-based slide surface difficult to transport into the Ni-based intermediate layer. This reduces the amount of Sn—Ni—Cu system compound formation by the bonding of Ni originally contained in the Ni-based intermediate layer and Sn and Cu contained in the Sn-based overlay, which relatively increases the percentage of Sn—Ni compound formation, thereby further improving the anti-seizure properties of the slide member. The Sn-based bottom layer/region is preferably 15 μm or thinner from the standpoint of anti-fatigue properties.

The cross section of the intermediate layer is typically observed and measured by observation instruments or methods such as FIB-SIM (Focus Ion Beam Scanning Image Microscope), SEM (Scanning Electron Microscope), TEM (Transmission Electron Microscope), EDS/EDX (Energy Dispersive X-ray Spectroscopy), and WDX (Wavelength Dispersive Spectroscopy). The thickness of the Sn-based bottom layer/region and the Sn-based slide layer/region is given by the maximum thickness measured within the observation field of the observation instruments or methods exemplified above.

The Ni-based intermediate layer preferably contains 0.01 mass % or more and 3 mass % or less of Fe. Fe content within the Ni-based intermediate layer allows formation of FeNi₃ from the bond of Ni and Fe within the Ni-based intermediate layer. The presence of FeNi₃ within the Ni-based intermediate layer increases the percentage of Ni having defective lattice within the Ni-based intermediate layer. The presence of defective lattice facilitates the diffusion transport of Sn having transported into the Ni-based intermediate layer from the Sn-based overlay and the diffusion transport of Ni within the Ni-based intermediate layer, thereby facilitating bonding of Sn and Ni. This means that Sn—Ni system compounds such as Ni₃Sn₄ are made easier to form to improve the anti-seizure properties of the slide member. Fe content of 0.01 mass % or greater within the Ni-based intermediate layer reinforces the above described advantages attributable to Fe. Fe content of 3 mass % or less within the Ni-based intermediate layer, on the other hand, optimizes the level of strains within Ni of the Ni-based intermediate layer to prevent the Ni-based intermediate layer from being too brittle.

### BRIEF DESCRIPTION OF THE DRAWINGS

FIG. 1 is a cross sectional view of a slide member according to one embodiment of the present invention illustrating a double layered Sn-based overlay;

FIG. 2 is a cross sectional view of a slide member having a single layered Sn-based overlay;

FIG. 3 is a cross sectional view of a slide member having a multilayered Sn-based overlay; and

FIGS. 4A and 4B taken together provide a chart indicating the results of the experiment;

FIG. 5 is a chart indicating the conditions applied in the anti-fatigue test; and

FIG. 6 is a chart indicating the conditions applied in the anti-seizure test.

### DESCRIPTION

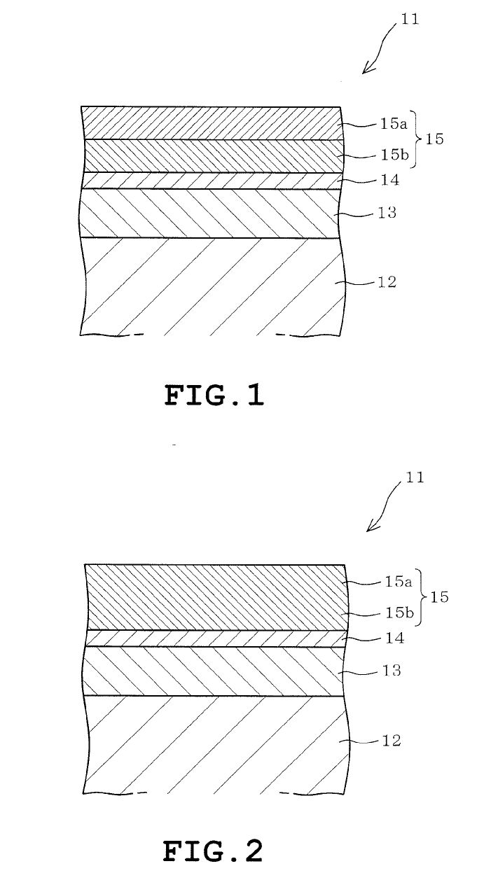

A slide member according to one embodiment of the present invention is illustrated in FIGS. 1 to 3 as slide member 11. Slide member 11 is composed of bearing alloy layer 13 provided over metal backing 12, Ni-based intermediate layer 14 provided over bearing alloy layer 13 and Sn-based overlay 15 provided over Ni-based intermediate layer 14. In one embodiment, bearing alloy layer 13 is exemplified as a Cu-based bearing alloy layer.

Sn-based overlay 15 of slide member 11 shown in FIG. 1 is configured as a double layer composed of Sn-based slide layer 15a and Sn-based bottom layer 15b.

Sn-based overlay 15 of slide member 11 shown in FIG. 2 is a single layer composed of Sn-based slide region 15a located at the top of slide member 11 and including a slide surface that contacts the counter member when in operation and Sn-based bottom region 15b located over Ni-based intermediate layer 14.

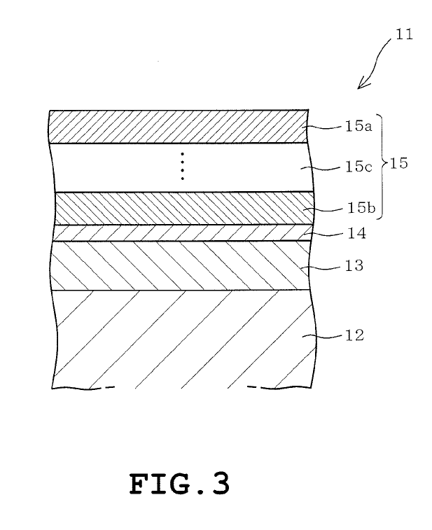

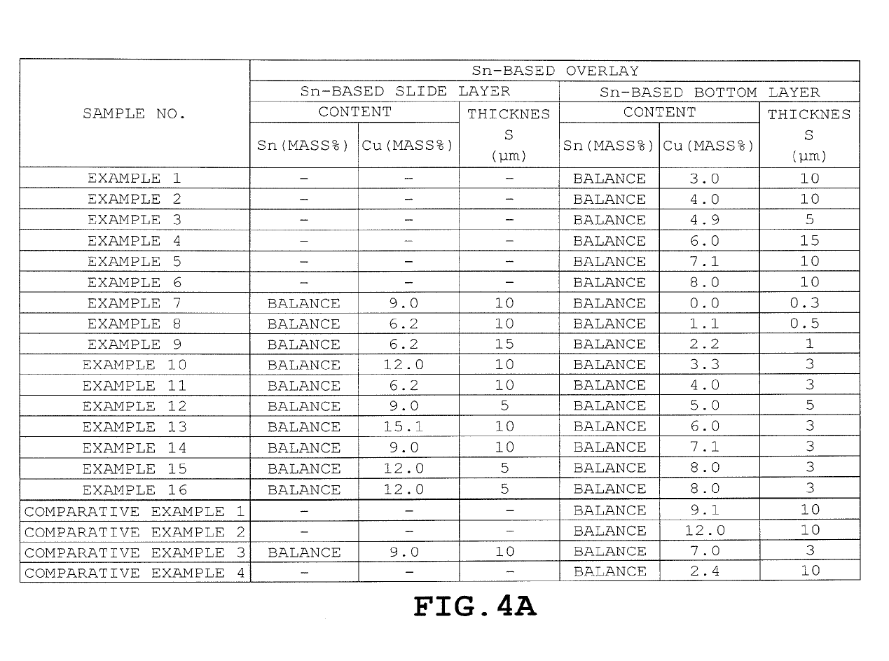

Sn-based overlay 15 of slide member 11 shown in FIG. 3 is configured as a multilayer composed of Sn-based slide layer 15a, Sn-based bottom layer 15b, and at least one Sn-based mid layer 15c interposed therebetween.

Next, a description will be given on the advantages of the improved anti-fatigue and anti-seizure properties of slide member 11 verified through an experiment according to one embodiment of the present invention.

The description begins with an explanation on how the samples used in the experiment were prepared. Samples identified as EXAMPLES 1 to 16 and COMPARATIVE EXAMPLES 1 to 4 were prepared so as to be similar in structure to slide member 11.

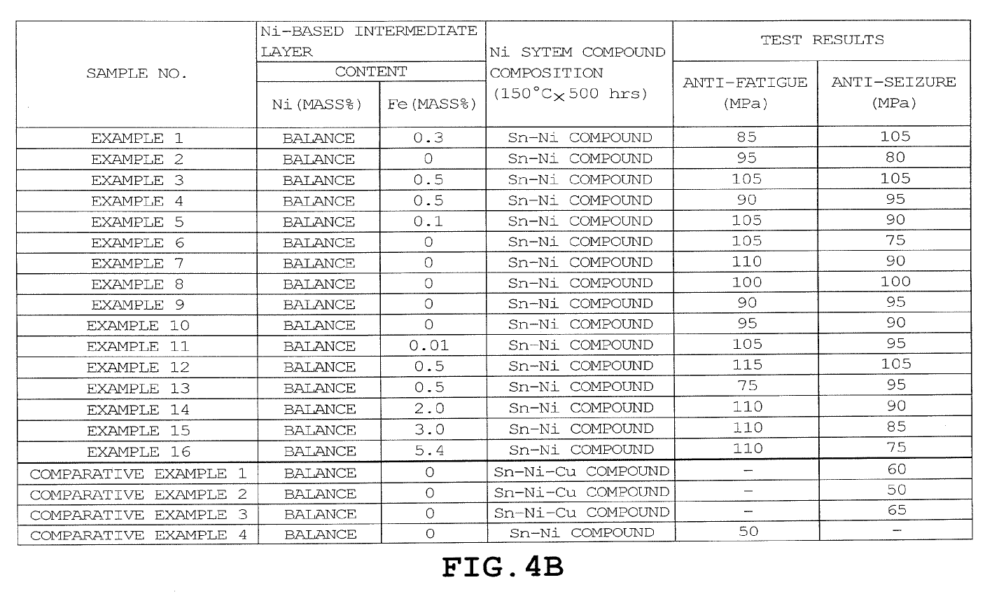

The preparation of the samples begins with coating a powdered Cu-based bearing alloy over a metal backing typically made of iron. The coated back metal layer was thereafter sintered and rolled to form the Cu-based bearing alloy layer over the back metal layer. The back metal layer and the Cu-based bearing alloy layer taken together constitute a bimetal. The bimetal was thereafter pressed to obtain a half bearing. Then, over the inner peripheral surface of the half bearing, a Ni-based intermediate layer having compositions indicated in FIG. 4B was formed by electroplating. The surface of the Ni-based intermediate layer was further electroplated to obtain a Sn-based overlay having compositions indicated in FIG. 4A. The samples listed in FIGS. 4A and 4B were prepared as described above.

EXAMPLES 1 to 6 each has a single layered Sn-based overlay and thus, the composition as well as the thickness of the Sn-based bottom region are the same as those of the Sn-based slide region. Thus, the composition and the thickness of the Sn-based slide region are not given under the column labeled “Sn-based slide layer” in FIG. 4A but are represented by the data given under the column “Sn-based bottom layer” in FIG. 4A.

EXAMPLES 7 to 16 each has a double layered Sn-based overlay made of a Sn-based bottom layer formed over the Ni-based intermediate layer and a Sn-based slide layer formed over the Sn-based bottom layer.

The Ni-based intermediate layers of EXAMPLES 1 to 16 were formed in a sulfamic acid bath containing nickel chloride, boric acid, and nickel sulfamate. The sulfamic acid bath used for EXAMPLES 1, 3 to 5, and 11-16 contains Fe. The thickness of the Ni-based intermediate layers of EXAMPLES 1 to 16 was made uniform at 3.5 μm.

The Sn-based overlays of EXAMPLES 1 to 16 were formed in a readily available sulfonic acid.

COMPARATIVE EXAMPLES 1 to 4 were formed substantially in the same way as EXAMPLES 1 to 16 except for slight differences in order to obtain different compositions and thicknesses in the Ni-based intermediate layer and the Sn-based overlay.

The Sn-based overlays of COMPARATIVE EXAMPLES 1, 2, and 4 are single layered and thus, the composition and the thickness of the Sn-based slide region are not given under the column labeled “Sn-based slide layer” in FIG. 4A but are represented by the data given under the column “Sn-based bottom layer” in FIG. 4A.

Adjustments were made in the thickness of the Sn-based bottom layer and the Sn-based slide layer of the samples by varying the current density and the duration of electroplating. For instance, the Sn-based bottom layer of EXAMPLE 9 was electroplated for 1 minute, whereas the Sn-based bottom layer of EXAMPLE 10 was electroplated for 3 minutes. Likewise, the Sn-based slide layer of EXAMPLE 9 was electroplated for 15 minutes whereas EXAMPLE 10 was electroplated for 10 minutes.

The aforementioned observation instruments such as FIB-SIM, SEM, TEM, and EPMA were used to observe the cross sections of the Sn-based overlay and Ni-based intermediate layer.

In the experiment, concentration analysis was performed using EPMA or SEM-EDX/WDX when the targeted layer was 2 μm or thicker. Concentration analysis was carried out within a rectangular region defined by a pair of first sides and a pair of second sides. The first side was taken along the thickness direction of the targeted layer and was dimensioned so as to occupy 80% of the thickness of the targeted layer and was disposed such that the center of the first side was coincidental with the center of the length of the targeted layer taken along the thickness direction. The second side was dimensioned to extend 20 μm perpendicularly relative to the thickness direction.

The concentration analysis was performed using TEM-EDX/WDX when the targeted layer was 2 μm or thinner. Similarly, concentration analysis was carried out within a rectangular region defined by a pair of first sides and a pair of second sides. The first side was taken along the thickness direction of the targeted layer and was dimensioned so as to occupy 80% of the thickness of the targeted layer and was disposed such that the center of the first side was coincidental with the center of the length of the targeted layer taken along the thickness direction. The second side was dimensioned to extend 2 μm perpendicularly relative to the thickness direction.

For instance, in EXAMPLE 7, the thickness of the Sn-based slide layer was measured using SEM at the magnification of 2000× whereas the thickness of the Sn-based bottom layer was measured using TEM at the magnification of 10,000×. Cu content within the Sn-based slide layer was measured using SEM-EDX whereas the Cu content within the Sn-based bottom layer was measured using TEM-EDX.

In EXAMPLE 10, the thickness of the Sn-based slide layer as well as the Sn-based bottom layer was measured using SEM at the magnification of 2000×. Images captured were analyzed to quantify the Cu content within the Sn-based slide layer and the Sn-based bottom layer, respectively.

In EXAMPLE 3, ICP (Inductively Coupled Plasma) analysis apparatus was used to quantify Fe content within the Ni-based intermediate layer. Because ICP analysis, by nature, is affected by the ingredients of the Sn-based overlay and the bearing alloy layer, Fe content was obtained by excluding the measurement of the content of such ingredients.

Fe content within the Ni-based intermediate layer was also obtainable by GDS (Glow Discharge Spectrometry) analysis apparatus.

The column labeled as “Ni system compound” indicates the Ni-system compound which occupied the greatest area within a certain cross sectional area taken in the proximity of the interface between the Ni-based intermediate layer and the Sn-based overlay of the sample which was heated at 150 degrees Celsius for 500 hours. The area of each Ni system compound was obtained by analyzing the images captured by the above described observation instruments and methods. The samples were heated under the above described conditions to evaluate the anti-fatigue and anti-seizure properties of the slide member in an environment closely resembling the operational environment of the product.

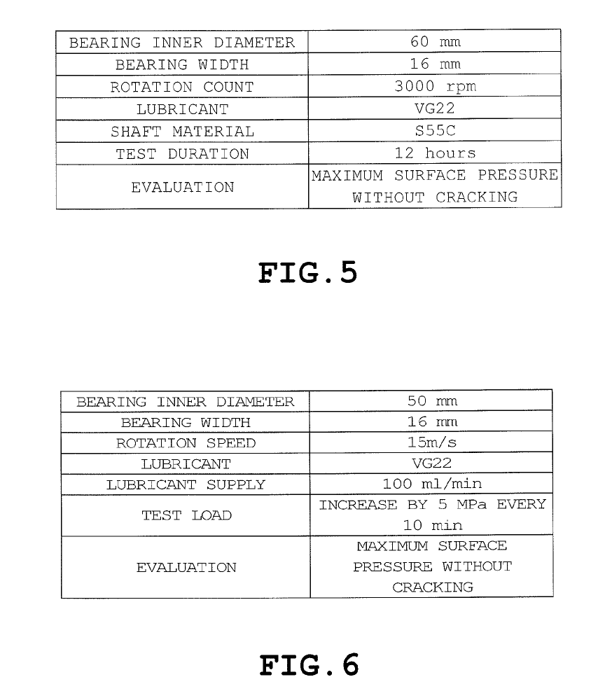

EXAMPLES 1-16 obtained as described above were tested for their anti-fatigue properties under the conditions indicated in FIG. 5 and for their anti-seizure properties under the conditions indicated in FIG. 6. COMPARATIVE EXAMPLES 1 to 3 were tested for their anti-seizure properties under the conditions indicated in FIG. 6. COMPARATIVE EXAMPLE 4 was tested for its anti-fatigue properties under the conditions indicated in FIG. 5.

The test results are indicated in FIG. 4B.

Below is an analysis of the anti-fatigue and anti-seizure test results.

It can be presumed from the comparison of EXAMPLES 1 to 16 and COMPARATIVE EXAMPLES 1 to 3 that EXAMPLES 1 to 16 exhibited superior anti-seizure properties than COMPARATIVE EXAMPLES 1 to in a pseudo-operational environment because “Ni SYSTEM COMPOUND COMPOSITION” of EXAMPLES 1 to 16 were Sn—Ni compounds.

Further, it can be understood from the comparison of EXAMPLE 1 and COMPARATIVE EXAMPLE 4 that EXAMPLE 1 exhibits superior anti-fatigue properties than COMPARATIVE EXAMPLE 4 because the Sn-based sliding region within the Sn-based overlay contains 3 mass % or more of Cu.

From comparison of EXAMPLE 6 and COMPARATIVE EXAMPLE 1, it can be understood that EXAMPLE 6 exhibits superior anti-seizure properties than COMPARATIVE EXAMPLE 1 because the Sn-based bottom region of EXAMPLE 6 contains 8 mass % or less of Cu.

Further, it can be understood from the comparison of EXAMPLES 10 and 13 that EXAMPLE 10 exhibits superior anti-fatigue properties than EXAMPLE 13 because the Sn-based slide layer within the Sn-based overlay contains 12 mass % or less of Cu.

It can be understood from the comparison of EXAMPLES 3 and 4 that EXAMPLE 3 exhibits superior anti-seizure properties than EXAMPLE 4 because the Sn-based sliding region within the Sn-based overlay contains less than 5 mass % of Cu.

Further, it can be understood from the comparison of EXAMPLES 7 and 8 that EXAMPLE 8 exhibits superior anti-seizure properties than EXAMPLE 7 because the Sn-based bottom layer is 0.5 μm or thicker.

It can be understood from the comparison of EXAMPLES 2 and 11 as well as EXAMPLES 6 and 15 that EXAMPLES 11 and 15 exhibit superior anti-seizure properties than EXAMPLES 2 and 16 because the Ni-based intermediate layer contains 0.01 mass % or more of Cu.

Though not shown, experiments based on samples having an intermediate layer containing Ni alloy instead of Ni exhibited substantially the same anti-fatigue and anti-seizure properties to those of the Ni-based intermediate layer.

Experiments based on samples having an Al-based bearing alloy layer instead of the Cu-based bearing alloy layer exhibited substantially the same anti-fatigue and anti-seizure properties to those of Cu-based bearing alloy layer. The samples having an Al-based bearing alloy layer were obtained by forming an Al-based bearing alloy layer according to general practice and forming an Ni-based intermediate layer and an Sn-based overlay in the listed sequence over the Al-based bearing alloy layer. The above described fabrication of a slide member is elaborated in the following process flow.

The process begins with melting an Al alloy formulating the Al-based bearing alloy layer and adding other ingredients as required. Then the Al-bearing alloy is continuously cast to obtain a sheet of Al-based bearing alloy which is pressure welded with a thin Al sheet. The sheet of Al-bearing alloy is thereafter pressure welded with a metal backing through the Al sheet to obtain a bimetal. The bimetal is processed into a half bearing as was the case in the Cu-based bearing alloy layer whereafter a Ni-based intermediate layer and Sn-based overlay were provided over the inner peripheral surface of the half bearing in the listed sequence to obtain a slide member having an Al-based bearing alloy layer.

The above described embodiment may be modified as required as follows.

The bearing alloy layer, the Ni-based intermediate layer, the Sn-based overlay, and the metal backing may contain unavoidable impurities. Further, each of the above described layers may contain hard particles such as oxides and carbides as well as solid lubricants such as sulfides and graphite.

The foregoing description and drawings are merely illustrative of the principles of the present invention and are not to be construed in a limited sense. Various changes and modifications will become apparent to those of ordinary skill in the art. All such changes and modifications are seen to fall within the scope of the invention as defined by the appended claims.

What is claimed is:

1. A slide member comprising:
a bearing alloy layer;
a Ni-based intermediate layer provided over the bearing alloy layer; and
a Sn-based overlay provided over the Ni-based intermediate layer;
wherein the Sn-based overlay comprises at least one layer, the Sn-based overlay including a first layer or region having a sliding surface and a second layer or region placed in contact with the Ni-based intermediate layer, and
wherein the first layer or region contains Sn and 3 mass % or more of Cu and the second layer or region contains Sn and 8 mass % or less of Cu.

2. The slide member according to claim 1, wherein Cu content in the first layer or region is 12 mass % or less.

3. The slide member according to claim 1, wherein Cu content in the second layer or region is less than 5 mass %.

4. The slide member according to claim 2, wherein Cu content in the second layer or region is less than 5 mass %.

5. The slide member according to claim 1, wherein the second layer or region is 0.5 μm or thicker.

6. The slide member according to claim 2, wherein the second layer or region is 0.5 μm or thicker.

7. The slide member according to claim 3, wherein the second layer or region is 0.5 μm or thicker.

8. The slide member according to claim 1, wherein the Ni-based intermediate layer contains 0.01 mass % or more and 3 mass % or less of Fe.

9. The slide member according to claim 2, wherein the Ni-based intermediate layer contains 0.01 mass % or more and 3 mass % or less of Fe.

10. The slide member according to claim 3, wherein the Ni-based intermediate layer contains 0.01 mass % or more and 3 mass % or less of Fe.

11. The slide member according to claim 5, wherein the Ni-based intermediate layer contains 0.01 mass % or more and 3 mass % or less of Fe.
